(19) United States
(12) Patent Application Publication
(10) Pub. No.: US 2016/0050560 A1
(43) Pub. Date: Feb. 18, 2016

(54) METHOD FOR TRANSPORTING LOCATION INFORMATION VIA AN AUTHENTICATION

(71) Applicant: ORANGE, Paris (FR)

(72) Inventors: Lionel Morand, Malakoff (FR); Julien Bournelle, Paris (FR); Sanaa El Moumouhi, Montrouge (FR)

(21) Appl. No.: 14/779,944

(22) PCT Filed: Mar. 28, 2014
(86) PCT No.: PCT/FR2014/050741

§ 371 Date: Sep. 24, 2015

(30) Foreign Application Priority Data
Apr. 2, 2013 (FR) 1352980

(51) Int. Cl. H04W 12/02; H04W 4/22; H04W 12/06; H04W 4/02; G06F 17/30; H04L 29/06

(52) U.S. Cl. CPC H04W 12/02; G06F 17/30312; H04L 63/08; H04W 12/06; H04W 4/02; H04W 4/22

(57) ABSTRACT

A method for transporting location information via an authentication. The invention concerns a method for attaching a user terminal to an operator access network, comprising: a step of transmitting a request for attachment to the access network, by the terminal, a step of receiving an authentication request from an authentication server of the operator, a step of generating an authentication response message, a step of obtaining an item of location information, a step of inserting the item of location information into the authentication response message, a step of transmitting the authentication response message.

### 1. FIELD OF THE INVENTION

The invention application applies to the field of telecommunications, and more particularly in the field of the locating of a user terminal when it attaches to a network access point. More specifically, the application invention relates to the use of an authentication protocol for transporting a location information item.

### 2. PRIOR ART

In certain circumstances, such as emergency calls for example, it is essential for an operator to locate a user, or at the very least the terminal that he or she is using, at the very moment when it attaches to the network of the operator. Furthermore, the location information is considered by an increasing number of statutes as being personal data, thereby having to be protected against disclosures other than those necessary for the provision of a requested service, or those required by law.

In cellular networks, such as the 3G or LTE/EPC networks for example, the geographic placement of the base stations is known accurately by their operator. Thus, a location information item is available to the operator whenever the mobile terminal of a user attaches to one of the operator's base stations.

A problem can occur as a result of the lack of location accuracy which is dependent on the size of the cell served by the base station.

Another problem arises from the fact that, in the case of the non-cellular access networks, such as WiFi, ADSL or FTTx access networks for example, the access points are not systematically pre-located by their operator. No information item is therefore available to the operator at the time of the attachment of a terminal to these access networks.

The 3GPP standard TS 23.203 version 12.0.0, defining the PCC (Policy and Charging Control) architecture, discloses a solution that makes it possible to return a location information item from a terminal to an operator via a request and response mechanism, but it can be implemented only by a specific signaling protocol and after the terminal has attached to its access point.

Furthermore, this solution also presents a problem of security because, since the exchanges are not secure, the confidentiality of the location information is not assured.

One of the aims of the invention is to remedy drawbacks of the prior art.

### 3. EXPLANATION OF THE INVENTION

The invention improves the situation by using a method for attaching a user terminal to an access network of an operator comprising a step of transmission of a request for attachment to the access network by the terminal, a step of reception of an authentication request from an authentication server of the operator, a step of generation of an authentication response message, the method further comprising:
a step of obtaining a location information item,
a step of inserting the location information item in the authentication response message,
a step of transmitting of the authentication response message.

By modifying the authentication response message, the terminal returns a location information item to the operator of the access network in its attachment phase. Thus, whether or not the operator has location information for its access point, it in all cases obtains a location information item for the terminal itself, which, furthermore, may be more accurate than that of the access point for locating the terminal.

Furthermore, the operator obtains this information item without delay, during the terminal attachment phase.

Furthermore, no additional signaling is needed because it is the signaling of the authentication protocol which is used.

Finally, since an authentication protocol is by definition secure, the confidentiality of the terminal location information item is assured.

This modification of the authentication response message according to the invention runs counter to the preconceived ideas of those skilled in the art, because an authentication protocol is restricted to the need to identify with certainty a user or a terminal authorized to access certain protected resources, and is not intended to convey information other than that strictly necessary for this need.

According to one aspect of the invention, the location information item comprises at least one parameter included in a group of parameters comprising:
GPS coordinates,
SSID identifier,
domain name,
cell identifier,
address of an access network attachment point.

Advantageously, the accuracy of location can be adapted according to needs by selecting one or more particular types of location parameter.

The GPS coordinates give the position of the terminal with an accuracy of the order of one meter. They are available when the terminal has a so-called GPS (Global Positioning System) function which requires the capacity to process the signals transmitted by the GPS positioning satellites.

The SSID identifier is that of the WiFi access point to which a terminal attaches. The operator stores the street address of all the WiFi access points that it manages. The location by street address is less accurate than the GPS coordinates, but may be more useful in certain cases.

The domain name identifies the access network to which the terminal is attached.

The cell identifier (Cell Id) makes it possible to know that the terminal is located in the coverage zone of the cell.

Any other type of address of the access network attachment point can be used for location purposes when there is a link between this address and the more or less accurate physical position of this access point.

According to one aspect of the invention, the above obtaining step comprises a step of selection of at least one location information parameter as a function of an accuracy criterion predetermined by a quality of service constraint.

Advantageously, the terminal can select from different types of location parameters when a number are available to it. It is possible for it to adapt the degree of accuracy to the location needs of a service requested of the operator.

For example, if a terminal connects by WiFi to an access point, the SSID will be able to be used as location information inserted into the authentication response message, in preference to coordinates supplied by the GPS function of the terminal. The operator will be able to consult its subscriber database in order to obtain, for example, the physical address of the subscriber to whom this SSID has been assigned. In certain cases, and for certain uses, the address of a dwelling or of a business is more accurate or more useful than GPS coordinates, such as, for example, the case of an emergency call transmitted from a building with a number of floors.

In another example, if a terminal connects to an xDSL or FFTx access point by a wired connection, the location of the access point will be as accurate as that of the terminal, and there is no need to use the GPS function of the terminal provided that the location information relating to the access point is accessible to the terminal.

The invention relates also to a method for processing a request for attachment of a user terminal to an access network of an operator, comprising a step of reception of an access authorization request following a request for attachment to the access network by the terminal, the method further comprising:
a step of transmission of an authentication request to the terminal,
a step of reception of an authentication response message,
a step of extraction from the authentication response message received of a location information item relating to the user terminal,
a step of storage of said information item in a database of the operator in order for it to be used subsequently by at least one predetermined communication service.

By virtue of this method for processing an attachment request which stores a location information item of a terminal in a database, the operator is able to provide communication services enriched with this location information and do so as soon as the terminal attaches to the access network.

Such an enriched communication service is, for example, the emergency call service. It is in fact particularly useful, even vital, for the user of the terminal, if he or she makes an emergency call following the attachment of his or her terminal to the access network, to be able to be immediately located by the emergency services.

Emergency calls are processed separately from ordinary communications and pass through a dedicated service platform of the operator. For this type of call, the regulations require the operator to provide a location information item for any call intended for an emergency call center. This legal obligation is still difficult to fulfill when the call does not pass through a fixed switched network or through a cellular network.

In the case of a call passed from a fixed switched network, there is a correlation between the calling number and a cadastral address.

In the case of a call passed from a cellular network, there is a correlation between the calling number and the zone covered by the cell, produced by virtue of a database such as the HLR (Home Location Register, in 3G) or HSS (Home Subscriber Server, in 4G).

In other cases, notably the case of a VoIP call via a non-cellular radiofrequency network, no location information is available according to the prior art at the time of attachment. By virtue of the invention, the operator has an accurate location information item even in these cases, and can therefore add it or make it available when transferring a VoIP call to an emergency call center.

According to one aspect of the invention, the method for processing an attachment request comprises a step of deletion of the location information item from the database when the terminal detaches from the access network. Thus, in the jurisdictions where the location data of a user are to be treated by the operator as personal data, they are used only for the needs of supplying a particular service to a user, and they are deleted from the databases of the operator as soon as this service is no longer to be provided.

According to one aspect of the invention, the step of extraction of the location information item of the method for processing an attachment request is followed by a step of rejection of the attachment request based at least on the location information item. Thus, it is possible to limit access authorizations as a function of a terminal and its location. For example, a business that has provided terminals to its employees may wish to limit the use thereof to business sites.

According to one aspect of the invention, the at least one predetermined communication service is an emergency call service.

The invention relates also to a method for using a location information item relating to a user terminal, said information item having been stored in a database upon the attachment of the terminal to an access network of an operator, the method comprising, on reception of a call from the terminal to a predetermined recipient, a step of obtaining said information item by interrogation of said database and a step of transferring the call at least according to said recipient and said location information item obtained.

By virtue of this method, it is possible for an operator to provide a location information item of the calling terminal, regardless of the type of access network to which the terminal has previously attached

This use method according to the invention is particularly useful, for example when it is implemented in a service platform processing emergency calls. In effect, the presence and the accuracy of the location information item, which is in this case of vital importance, is made possible even in the case of VoIP calls passed from non-cellular access networks.

The invention relates also to a device for attaching a user terminal to an access network of an operator, comprising a module for transmitting a request for attachment to the access network by the terminal, a module for receiving an authentication request from an authentication server of the operator, a module for generating an authentication response message, the device further comprising:
a module for obtaining a location information item,
a module for inserting the location information item in the authentication response message,
a module for transmitting the authentication response message.

This device can be implemented in a user terminal.

The invention relates also to a device for processing a request for attachment of a user terminal to an access network of an operator, comprising a module for receiving an access authorization request following a request for attachment to the access network by the terminal, the device further comprising:
a module for transmitting an authentication request to the terminal,
a module for receiving an authentication response message,
a module for extracting from the authentication response message received a location information item relating to the user terminal,
a module for storing said information item in a database of the operator in order for it to be used subsequently by at least one predetermined communication service.

This device can be implemented in an authentication server of the operator.

The invention relates also to a device for using a location information item relating to a user terminal, said information item having been stored in a database upon the attachment of the terminal to an access network of an operator, the device comprising a module for obtaining said information by interrogating said database and a module for transferring the call at least according to the recipient of the call and said location information item obtained.

This device can be implemented in a transit node managed by the operator and able to process the communication flows from a user terminal attached to an access network managed by the operator. This can for example be a routing node or a call control server.

The invention relates also to a user terminal comprising a device for attaching a user terminal to an access network of an operator, as described previously.

The invention relates also to an authentication server comprising a device for processing a request for attachment of a user terminal to an access network of an operator, as described previously.

The invention relates also to a transit network node comprising a device for using a location information item relating to a user terminal, as described previously.

The invention relates also to a signal, transmitted by a terminal, carrying an authentication response message, the message comprising a location information item relating to the terminal, and the message being intended for an authentication server of a network of an operator, the server being able to extract said information item from the message and to store said information item in a database.

The signal according to the invention makes it possible, for example, for an operator to include the location information item in a communication transferred to an emergency call center, for example.

The invention relates also to a computer program comprising instructions for the implementation of the steps of the method for attaching a user terminal to an access network of an operator, as described previously, when this method is executed by a processor.

The invention relates also to a computer program comprising instructions for the implementation of the steps of the method for processing a request for attachment of a user terminal to an access network of an operator, as described previously, when this method is executed by a processor.

The invention relates also to a computer program comprising instructions for the implementation of the steps of the method for using a location information item relating to a user terminal, as described previously, when this method is executed by a processor.

The invention relates finally to a storage medium that can be read by a user terminal, an authentication server or a service platform on which one of the programs which has just been described is stored, that can use any programming language and be in the form of source code, object code, or of intermediate code between source code and object code, such as in a partially compiled form, or in any other desirable form.

### 4. DESCRIPTION OF THE FIGURES

Other advantages and features of the invention will become more clearly apparent on reading the following description of a particular embodiment of the invention, given simply as an illustrative and non-limiting example, and the attached drawings, in which:

FIG. 1 presents an exemplary implementation of the method for attaching a user terminal to an access network of an operator, of the method for processing a request for attachment of a user terminal to an access network of an operator, and of the method for using a location information item relating to a user terminal, according to one embodiment of the invention,

FIG. 2 presents an exemplary structure of a device for attaching a user terminal to an access network of an operator, according to one aspect of the invention,

FIG. 3 presents an exemplary structure of a device for processing a request for attachment of a user terminal to an access network of an operator, according to one aspect of the invention,

FIG. 4 presents an exemplary structure of a device for using a location information item relating to a user terminal, according to one aspect of the invention.

### 5. DETAILED DESCRIPTION OF AT LEAST ONE EMBODIMENT OF THE INVENTION

The description below presents an exemplary implementation of the invention in an operator network operating according to a packet mode, such as an LTE/EPC network, based on the EAP protocol (Extensible Authentication Protocol, defined by RFC 3748 from the IETF), and in a use case of a call to an emergency service, but the invention applies also to other protocols and other use cases such as, for example, the IETF IKEv2 (Internet Key Exchange version 2) standard.

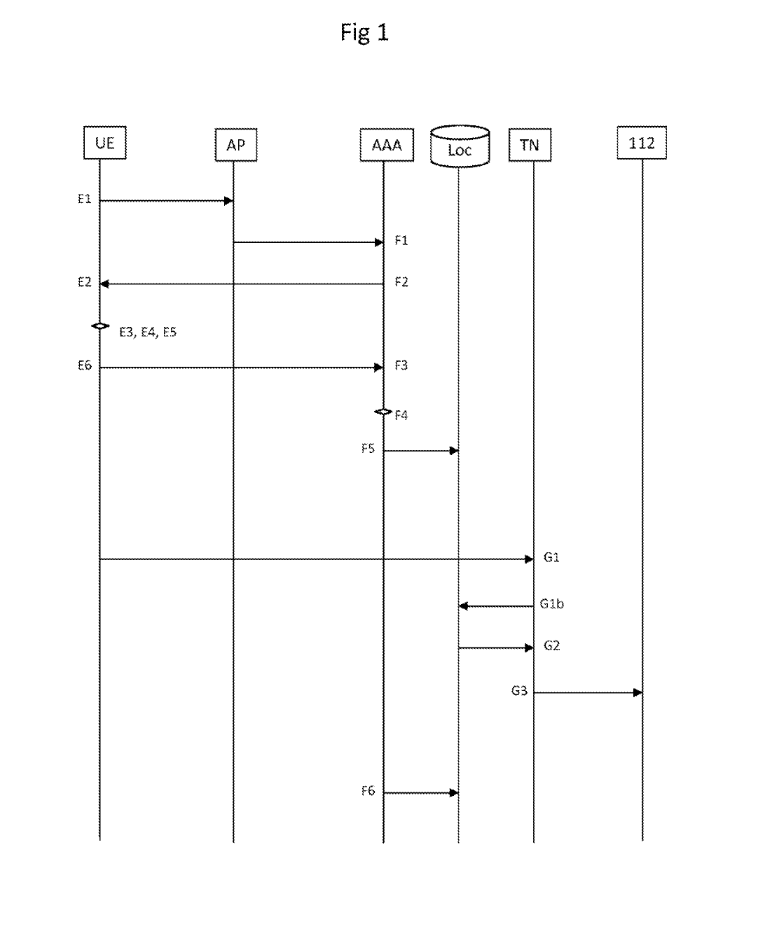

FIG. 1 presents an exemplary implementation of the method for attaching a user terminal to an access network of an operator, of the method for processing a request for attachment of a user terminal to an access network of an operator, and of the method for using a location information item relating to a user terminal, according to one embodiment of the invention.

The steps El to E6 are implemented by a user terminal and describe the method for attaching a user terminal to an access network of an operator, according to one embodiment of the invention.

In a step E1, the user terminal UE, or terminal UE, transmits a request for attachment to an access network represented by one of its access points AP. This access point AP checks the rights of access of the terminal UE, by consulting an authentication server AAA.

In a step E2, the terminal UE receives an authentication request originating from the server AAA, for example using the 3GPP TS 23.402 and 33.402 standard. This standard uses the EAP protocol which allows the use of different authentication methods for terminal accesses to the EPC core network via non-3GPP access points.

The message received in the step E2 can be embodied in the form of a message, of “EAP Request [. . . Location-TLV (GPS, SSID, . . . )]” type according to a modification of the EAP standard. For that, an extension to the authentication protocol must be defined via the “EAP TLV extensions method”. For example, the EAP-SIM method defines the possibility of adding an extra information item in TLV (Type-Length-Value) form. A generic TLV is therefore defined which indicates that it contains a location (request) parameter “Location-TLV” in the case of an EAP-Request. In this new TLV, TLVs are redefined which will indicate the information item concerned. Such a modified EAP message comprises, for example, a Location-TLV, which itself comprises:
the “status requested” parameter, which indicates that this is a request for information,
the “GPS information” parameter, which indicates that the GPS position of the terminal is required,
the “SSID” parameter, which indicates that there is a desire to know the SSID used by the terminal to connect when it is in a WLAN access,
the “domain name” parameter if it can obtain this information via DHCP for example.

The presence of the “Location (. . . )” parameter with “GPS” or “SSID” in the “EAP Request” message is novel with respect to the existing standard.

In a step E3, the terminal UE generates an authentication response message in accordance with the same EAP protocol.

In a step E4, the terminal UE obtains a location information item, that is to say relating to its positioning in space or in a network. This information item can comprise GPS coordinates obtained by consulting its embedded GPS function if it hosts such a function, or other types of location parameters. For example, it can comprise the SSID identifier of the access point if the latter is a WiFi access point.

If a number of types of location parameter are available, one or more of them can be selected by the terminal UE in a step E4b that is not illustrated. Thus, the location information item can comprise both the GPS coordinates and the SSID.

In a step E5, the terminal UE inserts the location information item obtained into the authentication response message generated in the step E3.

The message that is thus enriched in the step E5 can be embodied in the form of a message of “EAP Response [. . . Location-TLV (GPS, SSID, . . . )]” type according to a modification of the EAP standard. Such a modified EAP Response message comprises, for example, the following parameters:
the “service status” parameter, which can indicate whether the terminal has been able to correctly respond to the initial request,
the “GPS information” parameter, which will therefore contain the GPS positioning information obtained by the terminal,
the “SSID” parameter, containing the SSID to which the terminal is attached.

The presence of the “Location (GPS, SSID, . . . )” parameter in the “EAP Response” message is novel with respect to the existing standard.

In a step E6, the terminal UE transmits the authentication response message enriched in the step E5 to the server AAA.

In a step that is not illustrated, the terminal UE terminates its process of attachment to the access point AP after having received a confirmation of its authentication from the server AAA.

It will be understood that the method for attaching a user terminal to an access network of an operator according to the invention enables the terminal to transmit a location information item to an equipment item of the operator, here the server AAA.

The steps F1 to F7 are implemented by an authentication server and describe the method for processing a request for attachment of a user terminal to an access network of an operator, according to one embodiment of the invention.

In a step F1, the server AAA receives an access authorization request following the request for attachment of the terminal UE to the access point AP of the access network of the operator.

In a step F2, the server AAA transmits an authentication request to the terminal UE. This request has been described with reference to the step E2.

In a step F3, the server AAA receives an authentication response message from the terminal UE. This response message has been described with reference to the step E6.

In a step F4, the server AAA extracts the location information item from the response message.

In a step F5, the server AAA stores the extracted information item in a database Loc. This database Loc may be included in the server AAA, or in a remote equipment item.

It will be understood that the method for processing a request for attachment of a user terminal to an access network of an operator according to the invention enables an equipment item of the operator, here the server AAA, to store, for possible and subsequent use, a location information item relating to the terminal.

In a step F7, the server AAA deletes the location information item from the database, for example when the server AAA is notified that the terminal has detached from the access point, or after a predetermined delay has expired.

The steps G1 to G3 are implemented by a transit network node and describe the method for using a location information item relating to a user terminal, according to one embodiment of the invention. The example used here is that of an emergency call processing center, the call number of which varies according to country or region, and is, for example, 112 in Europe, or 911 in North America.

In a step G1, a transit network node TN receives a call intended for the emergency call center 112. Detecting that the recipient is 112, and knowing that 112 is a service requiring a location information item, the node TN, in a step G1b, interrogates the database Loc, using an identifier of the calling terminal, for example its telephone number.

In a step G2, the node TN obtains a location information item relating to the calling user terminal UE.

In a step G3, the node TN processes the call according to the recipient and the location information item obtained. For example, it adds said information item to at least one packet of the data flow intended for 112.

It will be understood that the method for using a location information item relating to a user terminal, according to the invention, makes it possible, between a point of origin and a point of destination of a communication, to provide the point of destination, here an emergency call processing center, with a location information item relating to the point of origin, here a user terminal.

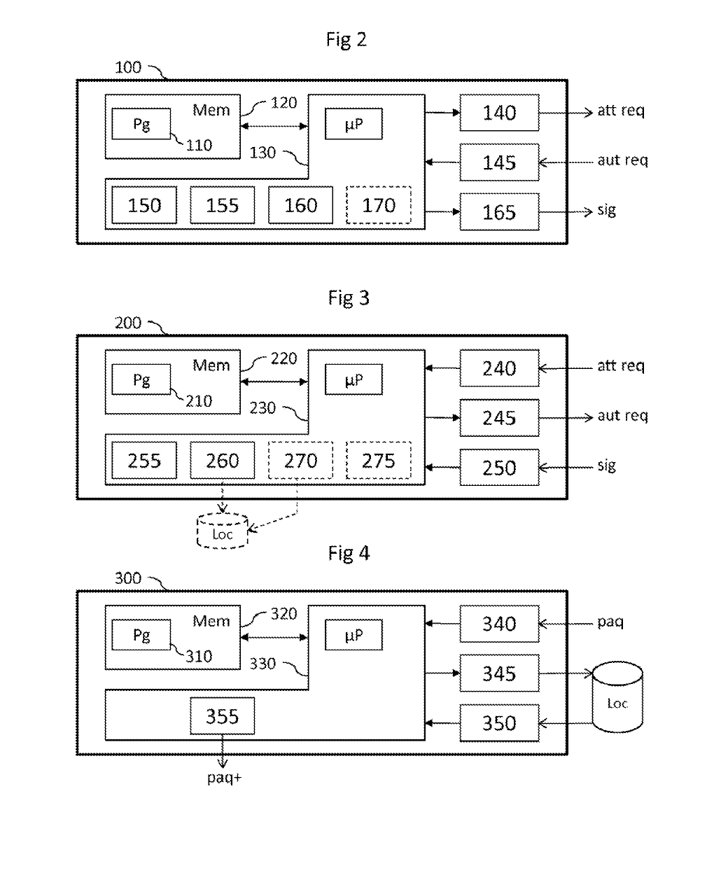

In relation to FIG. 2, there now follows a description of an exemplary structure of a device for attaching a user terminal to an access network of an operator, according to one aspect of the invention.

The attachment device 100 implements the method for attaching a user terminal to an access network of an operator, an embodiment of which has just been described.

Such a device 100 can be implemented in a user terminal suitable for attaching to a packet switched access network.

For example, the device 100 comprises a processing unit 130, equipped for example with a microprocessor μP, and driven by a computer program 110, stored in a memory 120 and implementing the attachment method according to the invention. On initialization, the code instructions of the computer program 110 are for example loaded into a RAM memory, before being executed by the processor of the processing unit 130.

Such a device 100 comprises:
a transmission module 140, suitable for transmitting a request for attachment (att req) to a packet switched access network,
a reception module 145, suitable for receiving an authentication request (aut req) from an authentication server,
a generation module 150, suitable for generating an authentication response message,
an obtaining module 155, suitable for obtaining a location information item relating to the terminal,
an insertion module 160, suitable for inserting the location information item relating to the terminal in the authentication response message,
a transmission module 165, suitable for transmitting a signal carrying an authentication response message (sig).

Advantageously, the device 100 can also comprise:
a selection module 170, suitable for selecting at least one parameter constituting the location information item.

In relation to FIG. 3, there now follows a description of an exemplary structure of a device for processing a request for attachment of a user terminal to an access network of an operator, according to one aspect of the invention.

The processing device 200 implements the method for processing a request for attachment of a user terminal to an access network of an operator, an embodiment of which has just been described.

Such a device 200 can be implemented in an authentication server suitable for authenticating a terminal attaching to a packet switched access network.

For example, the device 200 comprises a processing unit 230, equipped for example with a microprocessor μP, and driven by a computer program 210, stored in a memory 220 and implementing the processing method according to the invention. On initialization, the code instructions of the computer program 210 are for example loaded into a RAM memory, before being executed by the processor of the processing unit 230.

Such a device 200 comprises:
a reception module 240, suitable for receiving a request for attachment (att req) to a packet switched access network,
a transmission module 245, suitable for transmitting an authentication request (aut req) to a user terminal,
a reception module 250, suitable for receiving a signal carrying an authentication response message (sig) from a user terminal,
an extraction module 255, suitable for extracting a location information item relating to the user terminal from the response message received,
a storage module 260, suitable for storing the extracted information item in a database (Loc).

Advantageously, the device 200 can also comprise:
a deletion module 270, suitable for deleting the information from the database Loc,
a rejection module 275, suitable for rejecting the request for attachment of the user terminal according to the location information item extracted.

The database Loc can be implemented in the device 200 or in a separate device.

In relation to FIG. 4, there now follows a description of an exemplary structure of a device for using a location information item relating to a user terminal, according to one aspect of the invention.

The device 300 implements the method for using a location information item relating to a user terminal, an embodiment of which has just been described.

Such a device 300 can be implemented in a transit node situated between a point of origin and a point of destination of a communication.

For example, the device 300 comprises a processing unit 330, equipped for example with a microprocessor μP, and driven by a computer program 310, stored in a memory 320 and implementing the method of use according to the invention. On initialization, the code instructions of the computer program 310 are for example loaded in a RAM memory, before being executed by the processor of the processing unit 330.

Such a device 300 comprises:
a reception module 340, suitable for receiving packets of a communication flow (paq) from a user terminal,
an interrogation module 345, suitable for interrogating a remote database (Loc) comprising location information, using an identifier extracted from the packet flow received,
an obtaining module 350, suitable for obtaining, from the remote database (Loc) a location information item relating to the user terminal,
a processing module 355, suitable for processing the communication flow received by adding thereto the location information item obtained before its transmission (paq+) to its final recipient.

The modules described in relation to FIGS. 2 to 4 can be hardware or software modules.

The exemplary embodiments of the invention which have just been described are only a few of the embodiments that can be envisaged. They show that the invention makes it possible to return a location information item from a user terminal to an operator upon its attachment to the access network, with a degree of accuracy suited to the user service, even if the access point is not located, while keeping the information confidential and without specific signaling.

1. A method for attaching a user terminal to an access network of an operator, comprising a step of transmission of a request for attachment to the access network by the terminal, a step of reception of an authentication request from an authentication server of the operator, a step of generation of an authentication response message, characterized in that the method further comprises:
a step of obtaining a location information item,
a step of inserting the location information item in the authentication response message,
a step of transmitting of the authentication response message.

2. The method for attaching a user terminal to an access network of an operator as claimed in claim 1, characterized in that the obtaining step comprises a step of selection of at least one location information parameter as a function of an accuracy criterion predetermined by a quality of service constraint.

3. A method for processing a request for attachment of a user terminal to an access network of an operator, comprising a step of reception of an access authorization request following the request for attachment to the access network by the terminal, characterized in that the method further comprises:
a step of transmission of an authentication request to the terminal,
a step of reception of an authentication response message,
a step of extraction of a location information item relating to the user terminal, from the authentication response message received,
a step of storage of said information item in a database of the operator in order for it to be used subsequently by at least one predetermined communication service.

4. The method for processing a request for attachment of a user terminal to an access network of an operator as claimed in claim 3, characterized in that the at least one predetermined communication service is an emergency call service.

5. (canceled)

6. A device for attaching a user terminal to an access network of an operator, comprising a module for transmitting a request for attachment to the access network by the terminal, a module for receiving an authentication request from an authentication server of the operator, a module for generating an authentication response message, characterized in that the device further comprises:
a module for obtaining a location information item,
a module for inserting the location information item in the authentication response message,
a module for transmitting the authentication response message.

7. A device for processing a request for attachment of a user terminal to an access network of an operator, comprising a module for receiving an access authorization request following a request for attachment to the access network by the terminal, characterized in that the device further comprises:
a module for transmitting an authentication request to the terminal,
a module for receiving an authentication response message,
a module for extracting from the authentication response message received a location information item relating to the user terminal,
a module for storing said information item in a database of the operator in order for it to be used subsequently by at least one predetermined communication service.

8. (canceled)

9. A user terminal comprising a device for attaching a user terminal to an access network of an operator, comprising a module for transmitting a request for attachment to the access network by the terminal, a module for receiving an authentication request from an authentication server of the operator, a module for generating an authentication response message, characterized in that the device further comprises:
a module for obtaining a location information item,
a module for inserting the location information item in the authentication response message,
a module for transmitting the authentication response message.

10. An authentication server comprising a device for processing a request for attachment of a user terminal to an access network of an operator, comprising a module for receiving an access authorization request following a request for attachment to the access network by the terminal, characterized in that the device further comprises:
a module for transmitting an authentication request to the terminal,
a module for receiving an authentication response message,
a module for extracting from the authentication response message received a location information item relating to the user terminal,
a module for storing said information item in a database of the operator in order for it to be used subsequently by at least one predetermined communication service.

11-15. (canceled)
